(19) United States
(12) Patent Application Publication
(10) Pub. No.: US 2006/0190321 A1
(43) Pub. Date: Aug. 24, 2006

(54) Method and computing system for games, lottery and/or advertising campaign events using SMS or multimedia messages

(76) Inventors: Eurico Pinto Martins Nicho, Sao Domingos De Rana (PT); Egidio Fernando Pinto Da Silva, Cascais (PT)

Correspondence Address: INDIANAPOLIS OFFICE 27879;BRINKS HOFER GILSON & LIONE, ONE INDIANA SQUARE, SUITE 1600, INDIANAPOLIS, IN, 46204-2033, US

(21) Appl. No.: 11/022,618

(22) Filed: Dec. 27, 2004

(51) Int. Cl. G06Q 30/00

(52) U.S. Cl. 705/14

(57) ABSTRACT

This invention concerns a method and computing system for game, lottery and advertising campaign events in order to encourage the use of chained SMS or Multimedia messages where the sender, responsible for supporting all associated costs, becomes eligible for winning randomly awarded prizes set according to predetermined rules, using the cellular phone channel, in theory, reaching all cellular phone users, without breaking any mobile network service operator database privacy. It is characterized by: The use of a network computing system, connected to the mobile network operator numbers, who receive cellular phone messages and forward them to a computing system management platform. The messages are then assigned a sequential number by order of arrival to the system, all numbers are logged and the user is notified of this number and invited to forward one or more potential participant phone numbers to a specific phone number; the management platform, using a group of software applications will then send the future participant a message inviting him/her to join the game; if the participant whishes to enter the chain, he/she will have to send a message stating the arrival number of the participant who inserted him/her in the chain as well as one or more cellular phone numbers of prospective participants, it is therefore always possible to identify the origin and all the members of a any given sequence.

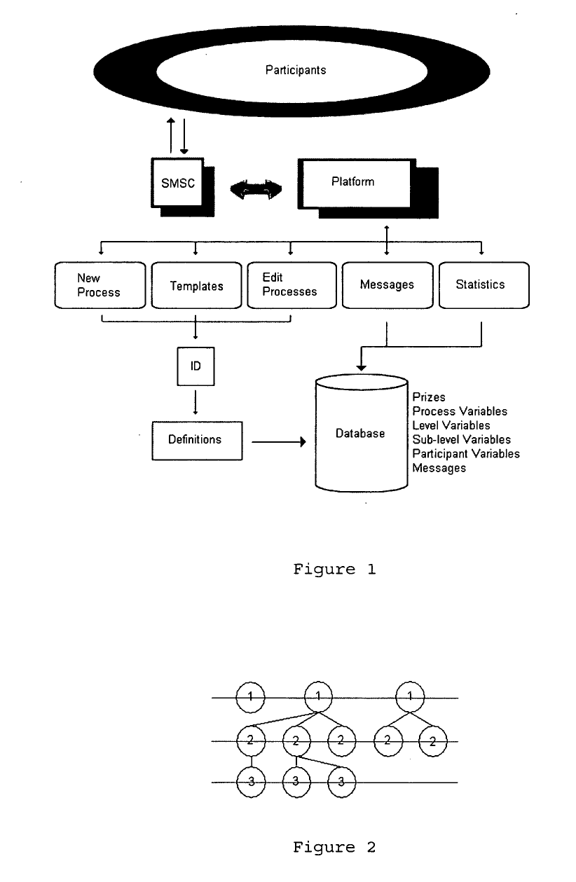

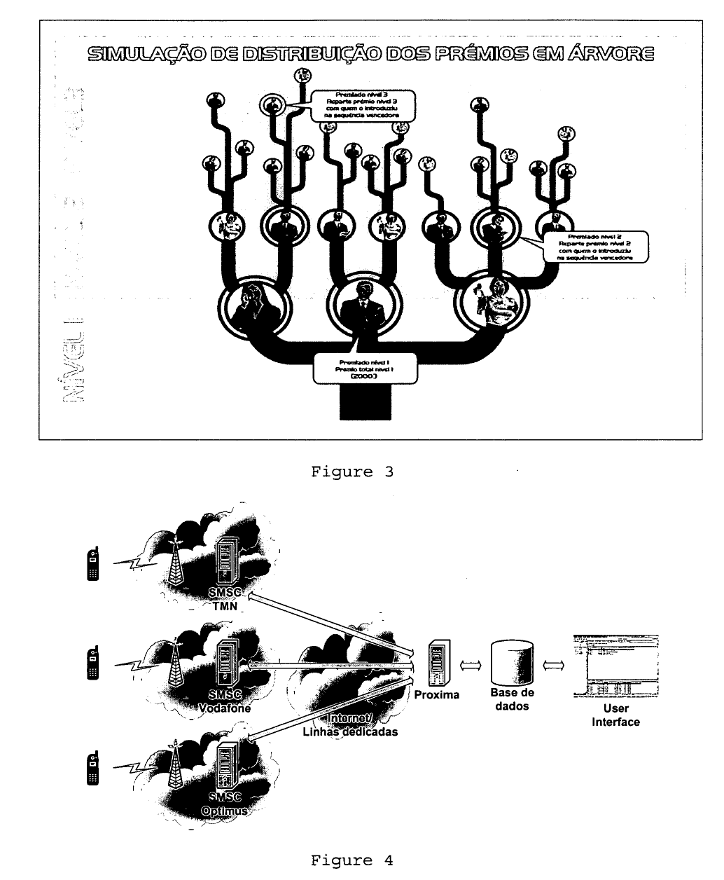

### SCOPE OF THE INVENTION

This invention concerns a method and computing system for games, lottery and/or advertising campaign events, in order to encourage the use of chained or tree structured SMS or Multimedia messages, where the sender, responsible for supporting all associated costs, becomes eligible for winning randomly awarded prizes set according to predetermined rules, using the cellular phone channel, in theory, reaching all cellular phone users, without breaking any mobile network service operator database privacy/confidentiality.

This is a new-chained SMS system. This service can be used either by gaming concessionaires, or by a company wishing to launch marketing campaigns for their products using the participation of their clients through SMS messages. In both cases, the service will be announced using complementary marketing campaigns, like television commercials, outdoors or even by the labels on the products they wish to advertise.

There are two different uses for this invention:
1) For companies wishing to promote their products.
2) For entities whose prime goal is to create a new type of game/lottery.

The main differences between the two uses are:

In the case of the game/lottery, the cost of the message will have to include, not only the mobile network service operator costs, but also an amount to be used in the prize money.

In the case of entities, the cost of the message could just pay the message fee charged by the mobile network service operator or include a small additional amount (this amount could be used to pay for the services or to promote the use of the messages).

Previous Technique

Some mobile network service operators have been using SMS messages in order to promote some of their services to their clients. The mobile network service operators send, for example, messages to their users when they leave the country informing them of roaming services.

The use of SMS messages in votes, polls, and fund-raisers by means of a SMS sent to a predetermined phone number is also very common.

The use of messages sent to some phone numbers in order to receive cellular phone ring tones and logos is also possible.

The first technique, described above, can only be used with the clients of the operator and only in order to promote the operator's own services/products.

The current legal frame forbids the use of databases, guaranteeing the privacy of those databases. In these circumstances, third party promotional messages are not allowed. Nor can a chain system based on cellular phone numbers from different mobile network service operators' databases be used.

As a result, an entity will not be able to send promotional messages to all the users of a mobile network service operator, let alone to all the cellular phone users.

In some games, in order to receive a number that allows you to complete a certain grid (published in the newspapers) you can send a message to a phone number and obtain more numbers that would allow you to complete that grid.

The applicants have no knowledge of the rules dictating the attribution of the numbers and therefore are unaware if this attribution is random, or even if they can ever complete the grid no matter how many messages are sent.

There is also the case of a fuel company that asks people to send a message to a certain number insuring them that a prize will always be awarded. We are unaware if there is a random system used to award those prizes.

The techniques we have just described are based in business models where the user is invited to use SMS messages while supporting all the costs involved in that use and with no incentive for the user to tell his friends about that service and by doing so create a chain system.

The applicants have no knowledge of a lottery/game using SMS messages that enables the awarding of any physical or large amount monetary prizes

### SUMMARY OF THE INVENTION

With this new invention we aim to create a system of chained SMS messages, which, without using legally protected databases, will generate a chain system that comprises many of the cellular phone users, and in theory, all the users of all the mobile network service operators that exist in the market

This invention inserts itself in the Promotional Marketing Products and Services areas, by the use of lotteries or games using cellular phone messages, commonly known as SMS, or by using third generation cellular phones MULTIMEDIA messages, aiming to reach the largest number of cellular phone users and promoting products or services by means of this new channel.

On the other side, the features of this new invention can also lead to a new game. By game, we mean a new type of game (with features that separate it from all those existing today, and that include a random factor as well).

This method can be easily adapted to a new Advertising/Promotional channel, a new Game, or a Television Game show.

We are therefore trying to solve two situations that the previous techniques don't address:

A) Encourage the promotion of SMS or Multimedia messages allowing the user to be eligible for a prize (products/services or even monetary prizes).

B) Use the cellular phone channel as yet another Promotional/Advertising channel or as another game or television game show, providing the access, in theory, to all the cellular phone users, ensuring the randomness of the prize awarding and making large amount monetary prizes possible.

In order to overcome the situations stated above, the cellular phone users will be invited to send messages containing other users' (friends of theirs) phone numbers to a given phone number. Thus, the database confidentiality issue is overcome.

On the other hand, the cellular phone users will be prompted to send more and more phone numbers because the awarding of the prizes will follow a tree structure that will award those prizes according to the sequential numbers of the message (which will be previously announced). The prizes will be awarded to the messages corresponding to the ordinal message arrival numbers and all those responsible for that message, in every level, will be awarded a prize. Therefore, if in the Campaign/Game/Lottery five levels (that will be explained latter) are set, there is a big probability that the winning message (with the biggest prize) will have a sequence of five users. This being so, all of them will have the right to a predetermined prize.

The situation we have just described for the largest prize is also used for the intermediary prizes.

By awarding the prizes by sequences, which is an innovation, this invention acquires a tree structure characteristic, that gives the top level users more probabilities of winning than those of subsequent levels (cf. picture 3).

Another feature, referred to as “viral” feature, is responsible for the possibility of each user being in every level and, theoretically speaking, that the winning message has five winners and that those winners are all the same person, for this, the user only has to include his own phone number in every level. The only difficulty is to determine what ordinal message number the system is receiving at every moment.

The object method of this invention is implemented by a computing system management platform. This platform has the ability to:

Identify all the variables defining a game, lottery and/or advertising campaign;

receive from the mobile network service operators the messages from participants sending messages;

verify the errors in the received messages;

log all the incoming messages in the corresponding level and assigning them a sequential arrival number;

send a confirmation message to the participant informing him of his arrival number or message error;

send a message to the participant inviting him to send one or more cellular phone numbers of other potential participants to a determined phone number;

send the prize winner an alphanumeric code number; these will allow to identify the origin of all the participants of any sequence and perform all the incoming messages database management;

avoid “SPAM” (unsolicited messages) at the request of the user;

block the access to the game/lottery to some users, minors, for instance.

### DESCRIPTION OF THE PICTURES

Picture 1 shows a bloc diagram that demonstrates the method sequence;

Picture 2 shows a schema of the level performance of the invention object method.

Picture 3 shows a simulation of a tree structure prize awarding; and

Picture 4 depicts a schema of the technical architecture of the platform.

### DETAILED DESCRIPTION OF THE INVENTION

The Schema of the object method of the invention's performance has features that are common to all channels, Promotional/Game/Television Game show, but it also presents different characteristics that allow the model to be adapted to all those situations.

The different characteristics are related to the rules of prize awarding, whether it concerns a Promotional/Game/or Television Game show channel, and also to the “market” you are aiming at.

The common features reside in the use of messages (SMS or Multimedia) in a tree structure and on the Computing System required (Hardware, Network Communication and Software), in other words, on the management platform.

The first promotion of the message (whether it is intended for a product or game) will take place during a television program with a considerable audience, in order to close the first level of the game as soon as possible (as explained bellow).

Several levels will be determined according to the market targeted, if possible never exceeding five or six levels. The levels will also be determined according to the market targeted. In Portugal, for example, the first level could be set at 10 000, meaning that the first 10 000 users would have more chances to win a prize.

The Computing System, through the management platform, will be linked through a network to the mobile service operator numbers that receive the incoming Cellular Phone messages, assigning a sequential received message number, by order of arrival to the system.

All the numbers will be logged and a message is sent to the user informing him of his number of arrival. On the other hand, one or more messages will be sent to the designated friend cellular phone number (the number of messages sent to the friend will depend on the following situations: Promotion, Game or Television Game Show channel and aimed objectives).

The platform will always send the friend a message containing his friend's incoming message number, inviting him to send as many friends' cellular phone numbers as possible to a specific phone number.

The platform can record the received messages' order of arrival, thus knowing the number where that message originated from.

If the friend wishes to enter the Game, he will have to send a message containing his friend's order of arrival, and the cellular phone number or numbers of his friends. It is therefore possible to identify the source and all of the participants of any given sequence, in such a way that, when the winning sequence is awarded, there are no doubts whatsoever either for the participants, or to the promoter of the Game/Channel/Lottery.

The underlying idea that we wish to convey is that the more numbers you send in, the bigger are the odds of you becoming the winner, because, by sending more messages, you are assigned more arrival numbers, but also because of the tree effect, that increases the odds of prize awarding, since the winning message will also reward all the messages it originated from.

To make the following description easier to understand, especially in regard with the means necessary to manage all the invention's object method system, the definition of a number of terms and concepts will be given, these definition are only valid within the scope of this description. In the bloc diagram on picture 1 the invention's object method system sequence is depicted. Thus:

Process—By process we understand the sequence of events featuring a game/lottery. The Process is defined by a set of customizable parameters.

Platform—Group of Software Applications in charge of performing the Process.

Participants—All the addressees of the messages sent by the Platform while performing a specific Process.

Tree—Schema used in order to organize the Participants' logs in a specific Process.

Level—Grading assigned to the “vertical” entry order in the Participant tree, as shown in pic. 1, being that Level 1 will correspond to the first Participants (those who initiated the Process). In picture 2, a schema of the levels of the invention's object method is represented. The horizontal lines intercept the Level of entry in the Process.

Sub-level—Subset of Participants in a specific level. It was created for prize awarding purposes.

Log Number—Entry number in the Participant tree. The Log Number count will be separate between Levels and will start at number 1 (one).

Process Manager—Person responsible for a process configuration and maintenance.

Template—Model used for the configuration of new Processes. A Template stands for a certain type of predefined process that tends to be repeatedly performed.

Prize—Sum awarded to some Participants based on their Log Number or some other variables, according to the Process definitions.

Functional Requirements Definition

Below, a detailed description of the Process management software is provided. The entry point of this software—main menu—allows you to access the main functions available in the Platform:

Novo Processo (New Process)—Definition of a new Process.

Templates—Definition of a new type of Process.

Edit Processes—Process Modification.

Messages—Message sending tool.

Statistics—Process data analysis tool.

Database—Archived information on all the logs performed in the Platform.

New Process

The implementation of a new Process can be based on a pre-existing Template or by executing the New Process Configuration Guide.

Template—All the variables defining a Process are pre-defined, except for the start date and end date variables. See Templates for more information on how to define a Template.

Configuration Guide—All the variables presented on the following list have to be configured. When the Configuration Guide is concluded, a confirmation menu listing a summary of all the defined variables will be shown.

Process Identification

Name identifying the Process in the Platform. It is essential to allow the simultaneous management and maintenance of multiple Processes. “ID” variable.

Process Definition

Identification and description of the variables that define the execution of the Process (Definitions).

Prizes

Definition of the prize awarding system:

Manual—The Process manager will appoint one by one the prize winning Log Numbers and their Prizes.

Automatic—The Process manager needs only to configure a Sub-level (minimum)

Process Variables

Number of Levels—Maximum number of Levels allowed in the Participant Tree. This variable can be set to dynamic, which means that a maximum number of Levels will not be determined.

Revenue per participant—Rate corresponding to the difference between the cost supported by the Participant per logging message and the costs associated with the logging process (return messages and the GSM Operator percentage).

Accumulated prize—Rate corresponding to the payment of accumulated prizes.

Start date—Process launching time and date. This variable can be left blank, which means that the Process will be manually launched using that option.

End date—Process termination date and time. This variable can be left blank, which means that the Process will be manually terminated using that option.

Level Variables.

Number of levels—Level definitions according to the variable. Level Variables.

Log Maximum—Maximum number of logs allowed in each Level. When this value is reached, the Level will be closed, meaning that no new Participant entries in this Level will be enlisted. All the new entries will then be enlisted in the subsequent Level where the maximum number of logs allowed hasn't been reached. This variable can be set to dynamic, which means that a maximum number of logs per Level will not be determined.

Level number—Number corresponding to the Tree Branch.

Prize by participant—Rate intended for the payment of the prizes by log message. This allows the amount available for the prizes to vary according to the log Level. This variation can be assigned by a percentage of the revenue per participant.

Amount for prizes per level—Amount that will be used to award the Prizes by Level. The predetermined rate will equal log maximum×prizes per participant+accumulated prizes/number of levels.

Number of Sub-Levels—Number of Participant sub-groups set for each Level. For example: If the log maximum of a specific Level is set to 1000, and the number of Sub-levels equals 5, we will then have 5 sub-groups of 200 Participants. This is only for prize awarding use. This variable will have to have a minimum value of 1 (one) in the manual Prize awarding.

Sub-levels—The sub-levels are defined according to the number of Sub-Levels variable. See Sub-level Variables.

Sub-Level Variables

Initial Log—Initial Log Number of the Sub-level. For instance: If the Sub-level comprises the logs numbered from 201 to 400, then the initial log will be 201. The predetermined value will equal 1 (one).

Final log—Last Log Number of the Sub-level. For instance: If the Sub-level comprises the logs numbered from 401 to 600, then the final log will be 201. The predetermined value will equal log maximum.

Amount for prizes per Sub-level—Amount that will be used to award the Prizes by Sub-level. The predetermined rate will equal (amount for prizes per level 1 number of sub-levels).

Amount for Ordinary Prizes per Sub-level—Amount that will be used to award the ordinary prizes by Sub-level. The predetermined amount will equal (amount for prizes per sub-level—prizes per end of sub-level—prizes per log numbers).

Number of ordinary prizes per Sub-level—Number of prizes to be awarded per Sub-level. The predetermined amount will be 1 (one).

Winning Log Numbers—The winning Log Numbers can be determined either randomly (before the start date) or manually.

Ordinary prize by Sub-level—Prizes awarded to the Participants logged in this Sub-level, according to their logging order. The predetermined amount will equal (amount for ordinary prizes per sub-level/number of prizes per sub-level). All the Participants in the located on higher Levels of the Tree “branch” will also have the right to a prize. For instance: The Participant who included the prize-winning Participant will also be awarded a prize.

End of Sub-level prize—Prize awarded to the Participant who “closes” the Sub-level, e.g., number of logs=final logs.

Number of largest number of logs prize winners—Number of Participants awarded with the largest number of logs prize, this prize is awarded to the Participants who have sent the largest number of log messages with a different MSISDN. In case of a tie the Participants with the largest number of log numbers will be the winner. If there is still a tie, the prize will be divided between the tied Participants.

Largest number of logs prize—Prize(s) awarded to the Participant(s) with the largest number of logs per Level. Each prize can be of a different amount.

Participant Variables

This group of variables is associated with each Participant Log on the Tree, and therefore shall be managed by the Platform itself.

Log Number—Participant Log Number on the Tree.

Level—Level where the Participant is logged.

Superior Log Number—Log Number corresponding to the Participant set on the above level in the Tree (the friend who referred this Participant).

Referenced MSISDN—MSISDN given when the log was made. (MSISDN-International Standard to represent cellular phone numbers (Mobile Station ISDN))

Prize—Prize awarded to the Participant. In most cases it will be 0 (zero).

WinningCode—Alphanumeric code number, composed by 8 characters, used to authenticate the winning Participant.

Messages

The following messages can be composed by text and/or any of the variables in the above list. For example: When the “Good Luck contestant Log Number, you are in level LEVEL” message is sent, the Platform will replace the variables by the data concerning the addressee: “Good Luck contestant 2500, you are in level 2”.

In order to modify any of the sentences described below, the text editing box available for that purpose must be used. The variables cannot be directly inserted. The “Add Variable” option should be used.

Main Message—Level, Log Number, Promotional text that will be inserted in the messages sent from the

Platform to the Participant, as if it were inviting the addressee to log in.

Log Message—Messages with a fixed format that must be sent to the Platform generating a Participant log: “ID Level Log Number ISDN”. The name of the Process must be placed first (which enables running multiple Processes simultaneously), followed by the Level and Log Number stated in the received Main, Message and, finally the MSISDN of a potential Participant.

Confirmation Message—Message sent to the Participants informing them of their log number and their Level. The predefined message will be “You have been enlisted in Level Level with the Log Number Log Number ”.

Error Message “Invalid Addressee”—Message sent to the Participant informing him of a non-existent cellular phone number. The predefined message will be “The addressee you have referred could not be reached. You have been enlisted in Level Level with the Log Number Log Number”.

Error Message “Invalid Log Number”—Message sent to the Participant who sent a non-existent Level and/or Log Number (Login Message). The predefined message will be “The Log Number you have sent is invalid”.

Prize Message—Message sent to the prize winners. The predefined message will be “Congratulations! You have just won Prize. Please fill in the winner form stating your code Winner Code”.

Templates

When a Template is defined the Process Manager will determine all the variables configuring a specific type of Process, except for the start date and end date variables.

Template Editing

When this option is selected a list of all the configured Templates in the Platform is shown. You can edit all the previously configured parameters in any of the existing Templates.

Process Editing

When this option is selected a list of all the configured Processes in the Platform is shown. Here you can manually activate the start of any Process or modify the Process Definitions, as previously stated.

Messages

This module will allow messages that are set outside the scope of the automatic Processes performance to be sent. The Platform manager will therefore be able to use this tool in order to communicate with the Participants of any Process, whenever he wishes to do so.

A selection of the addressees can be carried out according to the following criteria:

Process—Sends a message to all the Participants in a Process.

Level—Sends the message to all the Participants logged in a specific Level in a specific Process.

MSISDN—Sends the message to a specific cellular phone number.

Log Number—Sends the message to the Participant with this Log Number in a specific Process.

Statistics

This tool allows the statistic information coming from the execution of the Processes to be viewed. The data can also be exported into a CSV file (that can be read in Excel).

The following information will be made available by Process or by a group of Processes:

Number of logs;

Number of logs per Level;

Maximum number of logs performed by a participant;

Number of prizes awarded;

Total amount of the prizes awarded;

Largest prize awarded;

Average value of the prizes awarded;

Total value of the revenue;

Total value of the revenue—total value of prizes awarded.

Database

The Database is the Platform's archive. All the incoming messages are recorded as well as their incoming time and date. This information can be viewed and compared with the GSM Operators records in case of an audit by the “lottery jury”. Regarding the Processes, the following information will be stored:

Total number of logs;

Log listing—Message, sender MSISDN, timestamp (Precise record of the date, hour and minute);

Prized logs—MSISDN, prize value;

Accumulated prize—Amount intended for non-awarded Prizes.

Process Definitions—All the variables configured in the Process Definitions. Detailed record of the use of the Edit Processes function.

Process Sequence

The sequence of the functions in a Process will be presented next. The steps we are about to identify will not always occur in this sequence, because logging messages are expected to enter at different Levels and at any time during the execution of the Process.
1. Process Activation. N=1.
   Information for the prospective Participants (any cellular phone user) on the launching of the Process and the access number (number where the messages containing the friends' cellular phone numbers should be sent).
2. Logging messages corresponding to the Tree's N Level enter the Platform.
3. Error verification in the incoming messages.
4. The Logs are performed in the corresponding level.
5. Confirmation/error messages sent see Error! Reference source not found.
6. Main messages sent see Error! Reference source not found.
   Prospective Participants receive main messages. In order to log in the Process one or more messages containing the Log Number from the main message have to be sent to the access number.
7. N=N+1. Go back to step 2.
   End of Process.
8. Notification sent to the prize winners containing an 8 character alphanumeric code.
9. Payment request by the prize winners. This request will be filed via SMS or by the filling out the form available for that purpose. In order to claim the payment of the prize, the winner must refer the alphanumeric code mentioned above, his MSISDN and a Bank Identification Number (BIN).

Picture 3 depicts the technical architecture of the platform. As you can see it is comprised of:

The SMSC (Short Message Service Center) is the operators' written message platform. This system runs on a Store & Forward logic, which means, the messages are stored and then forwarded to the addressee.

All the SMS messages sent by GSM networks go through the operator's SMSC. The SMSC stores the messages and notifies the sender that the message was received. The SMSC will then try to deliver the message to the addressee. If the addressee is not available at that time, SMSC will retry sending it in increasing intervals until the message is delivered or until the end of its validity period is reached, by then, the message will be discarded.

The SMSC allows external software applications to connect to it, in order to send and/or receive messages. In these cases a short number (usually a 4 digit number) will be assigned to the software application, the users will perceive this number as a cellular phone number their messages can be sent to.

External software applications will usually connect to the SMSC via TCP/IP using a specific communication protocol. All the national (Portuguese) operator messages centres have implemented the same protocol, UCP. The physical connection can be made using the Internet network, or in cases where a larger message flux or when message confidentiality is required, through dedicated lines. Every connection, requiring configuration and access authorizations from the operators, is named a Large Account.

The GSM operators have implemented a business model that allows them to charge an added-value for every SMS sent to a Large Account, sharing the revenues with the partners providing the service. Based on the principle that the project described in this document will be implemented, this will be the easiest and more effective way to charge the users for this service (in this case, participating in the game).

Proxima

The connection to the message centres demands a software application that will implement a UCP communication protocol and manage the communication with the operators' SMSC, enabling the messages to be sent and received. This software application is known as a SMS Gateway.

The Proxima platform is divided into two main units: The SMS Gateway and the Application Server. The first, as mentioned earlier, is responsible for the communication between message centres. The last allows the provided SMS service logic to be implemented, using databases in order to record all the relevant information.

In the invention object method, Proxima's Application Server will be the unit responsible for logging all the participations in the game (received messages), sending replies to the participants and inviting new participants referred to by the participants. In accordance with the game rules, this unit will also be in charge of verifying each player's eligibility to win the prize.

Database

All the SMS game processes will have a non-volatile record in a database Thus, assuring that all the information “going through” the platform is recorded and available for latter analysis or audit.

The wide number of participants that can be forecasted for this particular type of game makes it crucial that the database engine be robust and reliable, able to handle several dozens of transactions per second, but also that backup copies and recovery mechanisms are put in place.

The performance and reliability of the chosen database cannot be considered without minding the supporting hardware, for these factors will largely depend on it.

User Interface

The User Interface module assembles all the software packages required for the performance of the platform. The management of the variables described above will be done using this interface—Functional Requirements. This user interface will be implemented as a Web page (HTML), in order to be used either locally or remotely.

For Example:

As an example, we have added a game simulation using the invention object method. This example is not binding.

PRIZE DISTRIBUTION PER LEVELS

| | LEVEL 1 | | | LEVEL 2 | | | LEVEL 3 |
|---|---|---|---|---|---|---|---|
| Value for the prizes included in the call | 0.50 | | | 0.50 | | | 0.50 |
| Level Number | 1 | | | 2 | | | 3 |
| Maximum Logs per Level | 80.000 | | | 600.000 | | | 4.000.000 |
| Sub-Levels | 4 | | | 3 | | | 2 |
| Maximum Logs per Sub-level | 20.000 | | | 200.000 | | | 2.000.000 |
| Maximum Revenue per Level | 40.000,00 | | | 300.000,00 | | | 2.000.000,00 |
| Prize awarding Percentage | 40.00% | | | 40.00% | | | 40.00% |
| Revenue per Sub-level | 10.000,00 | | | 100.000,00 | | | 1.000.000,00 |
| Prize awarding per Sub-level | 4.000,00 | | | 40.000,00 | | | 400.000,00 |
| Number of Prizes per Sub-level | | | | | | | |
| Largest Prize per Sub-level | 2.000,00 | | | 20.000,00 | | | 200.000,00 |
| Other Prizes per Sub-level | 2.000,00 | | | 20.000,00 | | | 200.000,00 |
| Largest Prize per Sub-level per Participant | 2.000,00 | | | 10.000,00 | | | 66.666,67 |
| Number of “Fractions” within the Sub-level | 9 | | | 9 | | | 9 |
| Prize for each “Fraction” within the Sub-level | 200.00 | | | 2.000,00 | | | 20.000,00 |
| Prize for sending more numbers within the Sub-level | 200.00 | | | 2.000,00 | | | 20.000,00 |
| | MSG | TOTAL | PARTICIP. | MSG | TOTAL | PARTICIP. | MSG |
| Relation of Prizes per Sub-level | NUMBER | 4.000,00 | | NUMBER | 40.000,00 | | NUMBER |
| message number | 2.000 | 2.000,00 | 200.00 | 20.000 | 2.000,00 | 2.000,00 | 200.000 |
| message | 4.000 | 4.000,00 | 200.00 | 40.000 | 2.000,00 | 2.000,00 | 400.000 |
| message | 6.000 | 6.000,00 | 200.00 | 60.000 | 2.000,00 | 2.000,00 | 600.000 |
| message | 8.000 | 8.000,00 | 200.00 | 80.000 | 2.000,00 | 2.000,00 | 800.000 |
| message | 10.000 | 10.000,00 | 200.00 | 100.000 | 2.000,00 | 2.000,00 | 1.000.000 |
| message | 12.000 | 12.000,00 | 200.00 | 120.000 | 2.000,00 | 2.000,00 | 1.200.000 |
| message | 14.000 | 14.000,00 | 200.00 | 140.000 | 2.000,00 | 2.000,00 | 1.400.000 |
| message | 16.000 | 16.000,00 | 200.00 | 160.000 | 2.000,00 | 2.000,00 | 1.600.000 |
| message | 18.000 | 18.000,00 | 200.00 | 180.000 | 2.000,00 | 2.000,00 | 1.800.000 |
| message | 20.000 | 20.000,00 | 2.000,00 | 200.000 | 200.000,00 | 20.000,00 | 2.000.000 |
| largest number of messages | | 200.00 | | | 1.000,00 | | |
| number of prize winners for the largest number of | 1 | | | 3 | | | 5 |
| messages by drawing | | 0.00 | | | 1.000,00 | | |
| VERIFICATION | | 0.00 | | | 0.00 | | |
| 03/07/24 | | | | | | | |

| | LEVEL 3 | | LEVEL 4 | | |
|---|---|---|---|---|---|
| Value for the prizes included in the call | | | 0.50 | | |
| Level Number | | | 4 | | |
| Maximum Logs per Level | | | 20.000.000 | | |
| Sub-Levels | | | 1 | | |
| Maximum Logs per Sub-level | | | 20.000.000 | | |
| Maximum Revenue per Level | | | 10.000.000,00 | | |
| Prize awarding Percentage | | | 40.00% | | |
| Revenue per Sub-level | | | 10.000.000,00 | | |
| Prize awarding per Sub-level | | | 4.000.000,00 | | |
| Number of Prizes per Sub-level | | | | | |
| Largest Prize per Sub-level | | | 2.000.000,00 | | |
| Other Prizes per Sub-level | | | 2.000.000,00 | | |
| Largest Prize per Sub-level per Participant | | | 500.000,00 | | |
| Number of “Fractions” within the Sub-level | | | 9 | | |
| Prize for each “Fraction” within the Sub-level | | | 200.000,00 | | |
| Prize for sending more numbers within the Sub-level | | | 200.000,00 | | |
| | TOTAL | PARTICIP. | MSG | TOTAL | PARTICIP. |
| Relation of Prizes per Sub-level | 400.000,00 | | NUMBER | 4.000.000,00 | |
| message number | 20.000,00 | 6.666,67 | 2.000.000,00 | 200.000,00 | 50.000,00 |
| message | 20.000,00 | 6.666,67 | 4.000.000,00 | 200.000,00 | 50.000,00 |
| message | 20.000,00 | 6.666,67 | 6.000.000,00 | 200.000,00 | 50.000,00 |
| message | 20.000,00 | 6.666,67 | 8.000.000,00 | 200.000,00 | 50.000,00 |
| message | 20.000,00 | 6.666,67 | 10.000.000,00 | 200.000,00 | 50.000,00 |
| message | 20.000,00 | 6.666,67 | 12.000.000,00 | 200.000,00 | 50.000,00 |
| message | 20.000,00 | 6.666,67 | 14.000.000,00 | 200.000,00 | 50.000,00 |
| message | 20.000,00 | 6.666,67 | 16.000.000,00 | 200.000,00 | 50.000,00 |
| message | 20.000,00 | 6,666,67 | 18.000.000,00 | 200.000,00 | 50.000,00 |
| message | 200.000,00 | 66.666,67 | 20.000.000,00 | 2.000.000,00 | 500.000,00 |
| largest number of messages | 5.000,00 | | | 25.000,00 | |
| number of prize winners for the largest number of | | | 10 | | |
| messages by drawing | 15.000,00 | | | 175.000,00 | |
| VERIFICATION | 0.00 | | | 0.00 | |
| Mar. 07, 1924 | | | | | |

1. Method and computing system for game, lottery and advertising campaign events encouraging the use of chained Multimedia or SMS messages, the sender being responsible for supporting all associated costs becoming eligible for winning prizes set according to predetermined rules and randomly awarded, using the cellular phone channel, reaching, in theory, all cellular phone users, without breaking any mobile network service operator database privacy, comprising the steps of:
providing a network computing system, connected to the mobile network operator numbers, who receive cellular phone messages and forward them to a computing system management platform;
assigning a sequential number by order of arrival to the system, recording all numbers, notifying the user of this number and inviting the user to forward one or more potential participant cellular phone numbers to a specific phone number;
using a software package, directing the management platform to send a message to the potential participant, inviting him/her to join the game;
if the user wishes to enter the chain, sending a message specifying the order of arrival of the user who placed him/her in the chain as well as the phone number of one or several potential participants, thus enabling the source and all the players in any sequence to be identified.

2. Method and computing system for game, lottery and/or advertising campaign events as stated in claim 1 comprising the step of providing instructions to the management platform to customise the game, lottery or advertising campaign features through predetermined rules and software applications.

3. Method and computing system for game, lottery and/or advertising campaign events, as stated in claim 1 comprising the step of associating a prize with the definition of levels of use (grading awarded by the management platform to the participants order of arrival), according to the number of planned users in accordance to predetermined rules.

4. Method and computing system for game, lottery and/or advertising campaign events, as stated in claim 1 comprising the steps of including an advertising message in addition to the messages sent by the computing system management platform required for the management of the chain.

5. Method and computing system for game, lottery and/or advertising campaign events as stated in claim 3 comprising the step of awarding the prizes through a draw or to the message with the log number matching the predetermined number of a specific level.

6. Method and computing system for game, lottery and/or advertising campaign events, as stated in claim 5 comprising the steps of, whether it is a game, lottery or just an advertising campaign, always awarding a prize to all the participants that originated the winning messages, and awarding a prize to the participant with the largest number of messages sent.

7. Method and computing system for game, lottery and/or advertising campaign events, as stated in claim 1 comprising the steps of, using an added-value message, to support the costs of the messages sent to the operator, and also paying an additional sum for the prizes, in games and lotteries, or for the improvement of the services in advertising campaigns.

8. Computing system management platform for the implementation of a method for game and/or advertising campaigns events, in accordance with the claims stated above, comprising:
means to identify all the variables defining a game, lottery and/or advertising campaign;
means to receive, from mobile service operators, messages sent by participants;
means to check for any errors in the messages received;
means to log all messages received on their matching level and to assign them a sequential order of arrival number;
means to send the participant a confirmation message with his/her number of arrival or notifying him/her of a message error;
means to send the participant a message inviting him/her to send one or several potential participant's phone numbers to a specific cellular phone number;
means to send the winner an alphanumeric code number; the means cooperating to identify the source of every player in any sequence, as well as manage the received messages database.

9. A computing system management platform, as stated in claim 8, comprising means, to configure every variable of the game/lottery or advertising campaign, including the number of levels and the maximum number of logs per level, the value for the difference between the cost supported by the participant per logging message and the costs associated with the logging process (return messages to the participant and percentage for GMS operator, the value intended for payment of accumulated prizes, and start and end date of the logging process).
